(19) United States
(12) Patent Application Publication
(10) Pub. No.: US 2018/0373285 A1
(43) Pub. Date: Dec. 27, 2018

(54) DEVICE FOR ELECTRICALLY CONTROLLING A CLUTCH

(71) Applicant: RAICAM DRIVELINE S.r.l., MONDOVI (IT)

(72) Inventor: Hervé Maurel, Amiens (FR)

(21) Appl. No.: 15/775,563

(22) PCT Filed: Nov. 10, 2016
(86) PCT No.: PCT/EP2016/077274

§ 371 Date: May 11, 2018

(30) Foreign Application Priority Data
Nov. 12, 2015 (FR) 1560820

(51) Int. Cl. G05G 5/03; G05G 1/44; G05G 5/05; G05G 1/38; F16D 48/06

(52) U.S. Cl. CPC G05G 5/03; G05G 1/44; F16D 2500/31413; G05G 1/38; F16D 48/06; G05G 5/05

(57) ABSTRACT

The invention concerns a device (1) for electrically controlling a transmission system, comprising a clutch pedal (2), said pedal (2) being intended to be hinged to a fixed support, said pedal (2) further comprising an area (4) to be pressed by the foot of a user, a force emulator (5) comprising a first part (6) intended to be linked to the fixed support and a second movable part (8) hinged to the clutch pedal (2), a resilient member (9) acting between the clutch pedal (2) and the first part (6), assistance means (20) comprising a first part (21) intended to be linked to the fixed support, and a second movable part (22) hinged to the clutch pedal (2), a resilient member (25) acting between the first part (21) and the clutch pedal (2).

The present invention relates to a device for electrically controlling a transmission system.

The transmission system may be a single or double clutch, a gearbox synchronizer for a manual transmission, an automated gearbox, a double clutch manual gearbox, or a clutch for coupling a heat engine with an electric machine when the latter are part of a propulsion chain of a hybrid vehicle.

In the case of electric control, the actuation of the clutch pedal is not intended to generate a force that acts mechanically on one or several intermediate elements in order to modify the state of the transmission system, this actuation of the pedal being done against a reaction force, for example exerted by fluid present in a hydraulic control.

In the applications with electric control set out above, no hydraulic control exerting a reaction force on the clutch pedal is used to move an element of the transmission system.

It may prove desirable to create a reaction or resistive force on the pedal when the latter is actuated, i.e., when the user presses on the latter, although this actuation does not act purely mechanically on the state of the transmission system. Such a reaction force in particular makes it possible not to destabilize a user who is more accustomed to hydraulic clutch controls. This reaction force on the pedal is then re-created by a force emulator.

Such a force emulator is for example known from application DE 10 2008 043 596. According to this application, the clutch pedal bears two cams, and each cam interacts with a spring when the pedal is actuated. Because of this interaction, a reaction force is exerted on the pedal despite the fact that the latter is integrated into an electric clutch control. Such a force emulator, which has many specific components, including the clutch pedal, is thus costly, cumbersome and not very interchangeable with a hydraulic control.

There is a need to provide a device for electrically controlling a transmission system, equipped with a force emulator, that is inexpensive and the implantation of which, when one wishes to replace a hydraulic control with an electric control, is easy. There is also a need to reproduce, as faithfully as possible, the feeling of the pedal of a traditional hydraulic control device so as not to bother the user of the vehicle.

The invention in particular aims to provide a simple, effective and economical solution to these problems, in whole or in part.

To that end, it proposes a device for electrically controlling a transmission system, comprising:
a clutch pedal able to be actuated by a user between an engaged position and a disengaged position, said pedal being intended to be hinged around a first axis relative to a fixed support, said pedal further including a bearing zone intended to be pressed by the foot of a user,
a force emulator comprising a first part intended to be linked to the fixed support and a second part movable relative to the first part, said second part being hinged relative to the clutch pedal around a second axis offset relative to the first axis, at least one resilient member acting between the clutch pedal and the first part so as to return the clutch pedal toward its engaged position,
assistance means comprising a first part intended to be linked to the fixed support, and a second part movable relative to the first part, the second part of the assistance means being hinged relative to the clutch pedal around a third axis offset relative to the first axis and relative to the second axis, at least one resilient member acting between the first part and the clutch pedal.

In such an electric control device, the position of the pedal can be detected using a sensor, as is known in itself.

The force emulator can generate a main resistive force at the pressing zone for the foot of the pedal and the assistance means can generate an auxiliary force, which is added to the main force. In particular based on the position of the hinge between the second part of the assistance means and the clutch pedal, it is possible to modulate or adapt the characteristic curve of the total resistive force, combining the aforementioned main resistive force and the auxiliary force.

The characteristic curve illustrates the variation of the corresponding force as a function of the travel of the clutch pedal between its engaged and disengaged positions.

The invention for example makes it possible, based in particular on the positions of the hinges, to come as close as possible to the characteristic resistive force curve of a pedal of a traditional hydraulic control device. Of course, the shape of the characteristic curve can vary as a function of specific demands by automobile builders, for example.

Furthermore, the device according to the invention makes it possible to use a traditional pedal as well as assistance means already traditionally used in hydraulic control devices, the positions of the corresponding hinges nevertheless being able to be adapted as needed. The cost of such an electric control device and its interchangeability with a traditional hydraulic control device are thus improved.

The aforementioned hinges can be pivot links or ball-joint links.

The second part of the force emulator may comprise a piston mounted translatably in the corresponding first part, and a connecting rod hinged around the second axis relative to the clutch pedal, the connecting rod also being hinged relative to the piston.

In this case, the resilient member of the force emulator can be mounted between the first corresponding part and the piston, or between the first corresponding part and the connecting rod, or between the first corresponding part and the pedal.

The resilient member of the assistance means can be mounted between the first and second corresponding parts.

The force emulator can be configured to generate a resistive force at the pressing zone of the pedal that increases substantially linearly with the travel of the pedal from its engaged position toward its disengaged position.

This force is for example positive over the entire travel of the pedal, i.e., it always tends to return the clutch pedal toward its engaged position. This force is a main component of the total reaction force generated both by the emulator and by the assistance means, at the bearing zone of the foot.

The assistance means can be configured to generate a resistive force at the bearing zone of the pedal that increases, then decreases with the travel of the pedal from its engaged position toward its disengaged position.

This force is an auxiliary component of the total reactive force generated both by the emulator and by the assistance means at the bearing zone of the foot. This auxiliary component can be lower in value than the aforementioned main component.

The assistance means can for example be configured to generate a resistive force at the bearing zone of the pedal that is maximal for a movement of the pedal comprised between 20 and 40%, preferably of about 30%, of the travel of said pedal between its engaged and disengaged positions.

The assistance means are configured to generate a positive resistive force at the bearing zone of the pedal, over a first part of the travel, then a negative force over a second part of the travel.

In this case, the assistance means are configured to generate a resistive force at the bearing zone of the pedal that is zero for a displacement of the pedal comprised between 50 and 70%, preferably about 60%, of the travel of said pedal between its engaged and disengaged positions.

The force emulator and the assistance means can be configured to generate a total resistive force at the bearing zone of the pedal that increases over a first part of the travel, until reaching a displacement of the pedal comprised between 30 and 60% of the travel of said pedal between its engaged and disengaged positions, then decreases over a second part of the travel, until reaching a displacement of the pedal comprised between 70 and 100% of the travel of said pedal, then increases again over a third part of the travel, until reaching the disengaged position of the pedal.

The value of the total resistive force, formed by adding the main component (always positive) and the auxiliary component (which may be positive or negative depending on the position of the pedal), is always positive. In other words, this total resistive force will always tend to return the pedal toward its engaged position.

The force emulator may include at least one sensor able to determine the position of the second part of the emulator, for example the position of the piston. It is then possible to determine the position of the pedal indirectly, by calculation.

The device may also include friction means at least at one of the hinge axes, so as to generate a hysteresis torque, preferably a variable hysteresis torque based on the position of the pedal.

The friction means may include a resilient wavy washer rotatably coupled to a first element of the corresponding hinge, said wavy washer including at least one protruding zone and at least one hollow zone, a second element of the hinge including at least one protruding member able to bear at least on the protruding zone of the wavy washer. The wavy washer is able to deform along its axis, which is also the axis of the corresponding hinge.

In this way, the formed hysteresis torque can be small or zero when the protruding member is located across from the hollow zone of the washer and the formed hysteresis torque can be significant when the protruding member is bearing on the protruding zone of the washer and greatly compresses this washer.

The wavy washer and the protruding member can be configured such that the hysteresis torque is small or zero when the pedal is in the idle or engaged position and the hysteresis torque is greater over the rest of the travel of the pedal.

The first part of the assistance means can be hinged on the fixed support. The second part of the assistance means can be translatable relative to the first corresponding part.

A coordinate system can be defined for example having, as origin, the hinge axis of the pedal on the fixed support, and including:
a first axis x passing through the hinge axis of the pedal on the fixed support, on the one hand, and through the hinge axis of the second part of the force emulator on the pedal, on the other hand,
a second axis y perpendicular to the axis x.

In this coordinate system (x; y), in the idle position of the pedal, i.e., in the engaged position, it is possible to define the following coordinates:
the hinge axis of the pedal on the fixed support has coordinates (0; 0),
the hinge axis of the connecting rod of the emulator on the piston has coordinates (x2; 0),
the hinge axis of the connecting rod of the emulator on the piston has coordinates (x3; y3),
the hinge axis of the second part of the assistance means on the pedal has coordinates (x4; y4),
the hinge axis of the first part of the assistance means on the fixed support has coordinates (x5; y5),
the pressing point of the foot on the pedal has coordinates (x6; y6).

According to one embodiment:
x2 can be comprised between 50 and 70 mm,
x3 can be comprised between 28 and 48 mm,
y3 can be comprised between 88 and 108 mm,
x4 can be comprised between 130 and 160 mm,
y4 can be comprised between −35 and −15 mm,
x5 can be comprised between 80 and 100 mm,
y5 can be comprised between 6 and 26 mm,
x6 can be comprised between 230 and 260 mm,
y6 can be comprised between −90 and −70 mm.

According to another embodiment:
x2 can be comprised between 33 and 53 mm,
x3 can be comprised between −4 and 16 mm,
y3 can be comprised between 110 and 140 mm,
x4 can be comprised between −7 and 13 mm,
y4 can be comprised between 30 and 50 mm,
x5 can be comprised between −34 and −14 mm,
y5 can be comprised between 56 and 76 mm,
x6 can be comprised between 230 and 270 mm,
y6 can be comprised between −30 and −10 mm.

Of course, the preceding values can be modified in whole or in part. In this case, the relative positions of the different hinge axes are preferably retained, like a change of scale.

The invention will be better understood and other details, features and advantages of the invention will appear upon reading the following non-limiting example in reference to the appended drawings, in which:

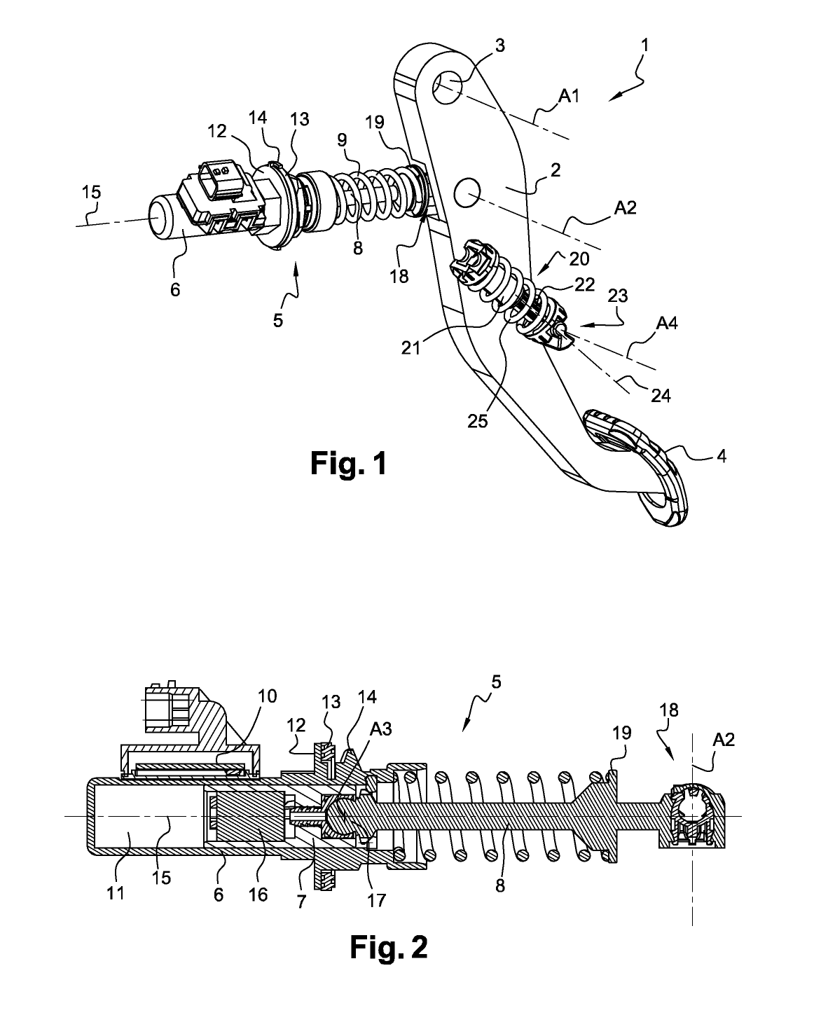

FIG. 1 is a perspective view of the device according to one embodiment of the invention,

FIG. 2 is a sectional view of the force emulator of the device of FIG. 1,

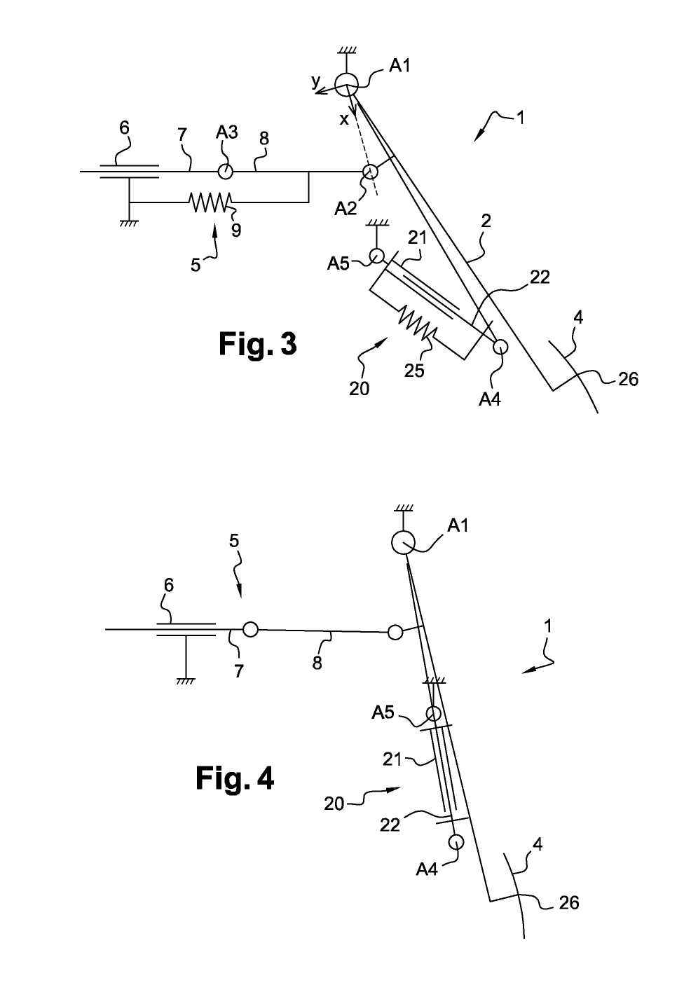

FIGS. 3 to 5 are views showing the kinematic diagram of the device in different positions of the clutch pedal, respectively in the engaged position, an intermediate position and the disengaged position,

FIG. 6 is a diagram in particular showing the forces generated by the force emulator and the assistance means, based on the travel of the clutch pedal,

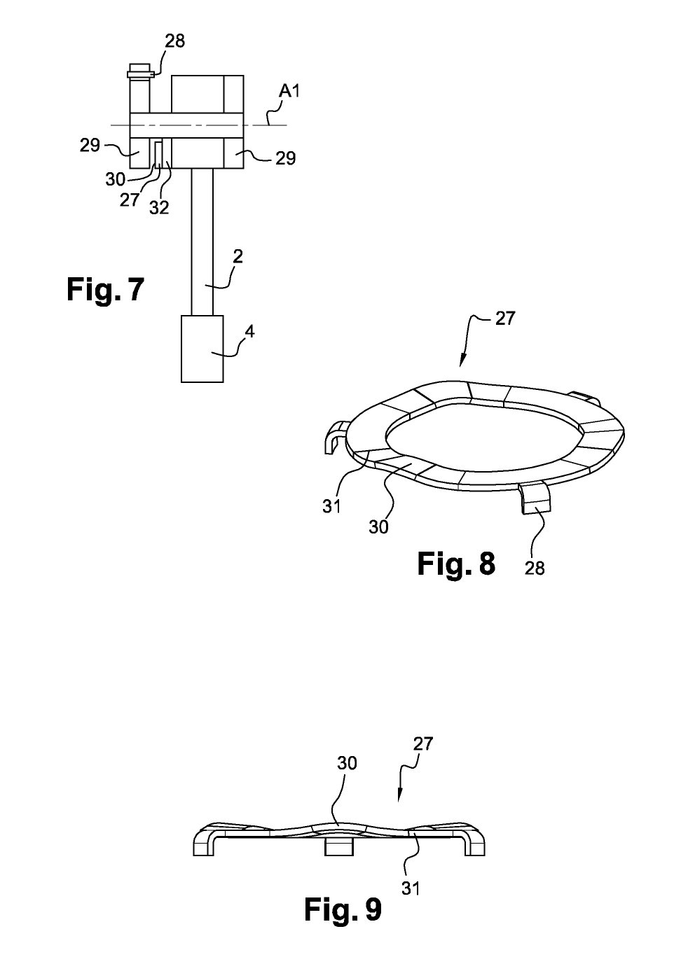

FIG. 7 is a schematic sectional view illustrating the hinge of the pedal on the fixed support, friction means being mounted at said hinge,

FIG. 8 is a perspective view of a wavy washer belonging to said friction means,

FIG. 9 is a side view of said wavy washer,

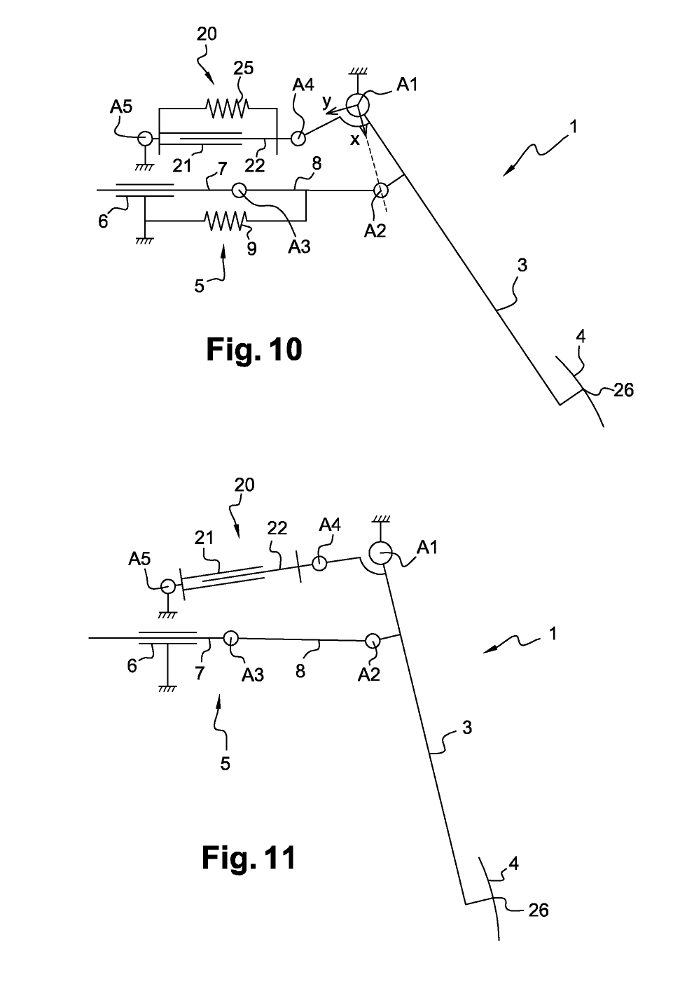

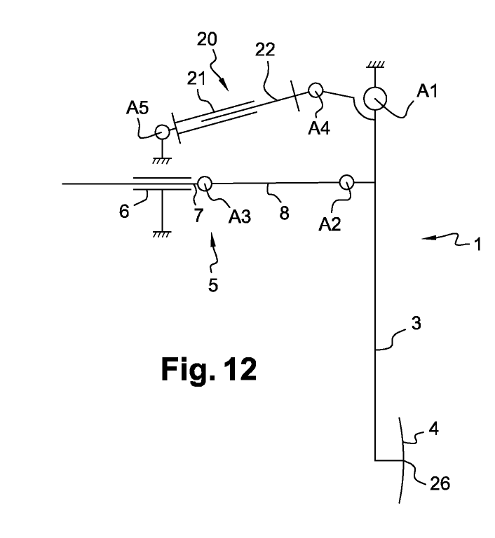

FIGS. 10 to 12 are views corresponding to FIGS. 3 to 5, illustrating an alternative embodiment of the invention.

FIGS. 1 to 9 show a device 1 for electrically controlling a transmission system, according to a first embodiment of the invention. The device 1 for example makes it possible to control a clutch of the type that is normally closed, equipping a gearbox of a vehicle.

The device 1 comprises a pedal 2 able to be actuated by a user between an engaged position and a disengaged position. The pedal 2 globally comprises a first end comprising a hole 3 serving as a passage for a hinge shaft, said shaft being mounted in a support for example fixed to the fire wall of the vehicle. The pedal 2 is thus hinged around an axis A1, on a fixed element of the vehicle.

The pedal 2 further comprises a second end, opposite the first end, comprising a zone 4 used for pressing of the foot of a user of the vehicle.

The device 1 additionally comprises a force emulator 5. As better seen in FIG. 2, the force emulator 5 comprises a body 6, a piston 7, a connecting rod 8, a resilient member 9, and a position sensor 10.

The body 6 is for example intended to be fastened to the fixed support. The body 6 comprises a hollow part 11 in which the piston 7 is mounted, a flange 12 extending radially outward, a gasket 13, and fastening means 14 of the bayonet type, capable of cooperating with means complementary to the support to provide the fastening of the body 6 on the support, the gasket 13 bearing on a radial wall of said support after fastening.

The piston 7 is mounted sliding in the hollow part 11, along a pin 15. A magnetic element 16 is mounted in the piston 7, at a first end of the piston 7.

A first end of the connecting rod 8 is hinged on a second end of the piston 7, using a ball-joint link 17. A second end of the connecting rod 8 is hinged on the pedal 2, using a pivot link or ball-joint link 18. The resilient member 9 is for example a helical compression spring and is mounted between the body 6 and an annular rim 19 of the connecting rod 8. The first resilient member 9 has a stiffness constant K1 for example comprised between 10 and 22 N/m. The first resilient member 9 thus opposes the translation of the connecting rod 8 relative to the body 6, along the pin 15.

During operation, the connecting rod 8 is thus able to pivot relative to the clutch pedal 2 around an axis A2 and the connecting rod is able to pivot relative to the piston around an axis A3.

The sensor 10 is supported by the body 6 of the emulator 5. The latter is a contactless and linear sensor and is able to measure the displacement of the magnetic element 16 relative to the body 6, and therefore the displacement of the piston 7 relative to the body 6.

The information provided by this sensor 10 can be used by a processing unit, for example integrated into the electronic control unit of the vehicle, to generate an input for an electrical actuator modifying the state of the transmission system, i.e., making it possible to control the clutch. It is thus possible to produce electrical control of the “clutch by wire” type. It is for example possible to perform “coasting”.

The device 1 further comprises assistance means 20 comprising a hollow body 21. The body 21 is hinged on the fixed support, at a first end, a piston being mounted at the other end of the body 21. The piston comprises a rod 22, the free end of which is hinged on the pedal 2, via a pivot link or ball-joint link 23 (FIG. 1). The piston and the rod 22 can be translated along a pin 24 relative to the body 21. A second resilient member 25, for example a helical compression spring, is mounted between the body 21 on the one hand, and an annular bearing surface of the rod 23 on the other hand.

The second resilient member 25 has a stiffness constant K2 for example comprised between 20 and 32 N/m. The second resilient member 25 thus opposes the translation of the piston and the corresponding rod 22 with respect to the body 21.

During operation, the rod 22 is thus able to pivot relative to the pedal 2, around an axis A4, the body 21 being able to pivot relative to the fixed support, around an axis A5.

FIGS. 3 to 5 show the device 1 of FIG. 1 in the form of kinematic diagrams in different positions of the clutch pedal 2.

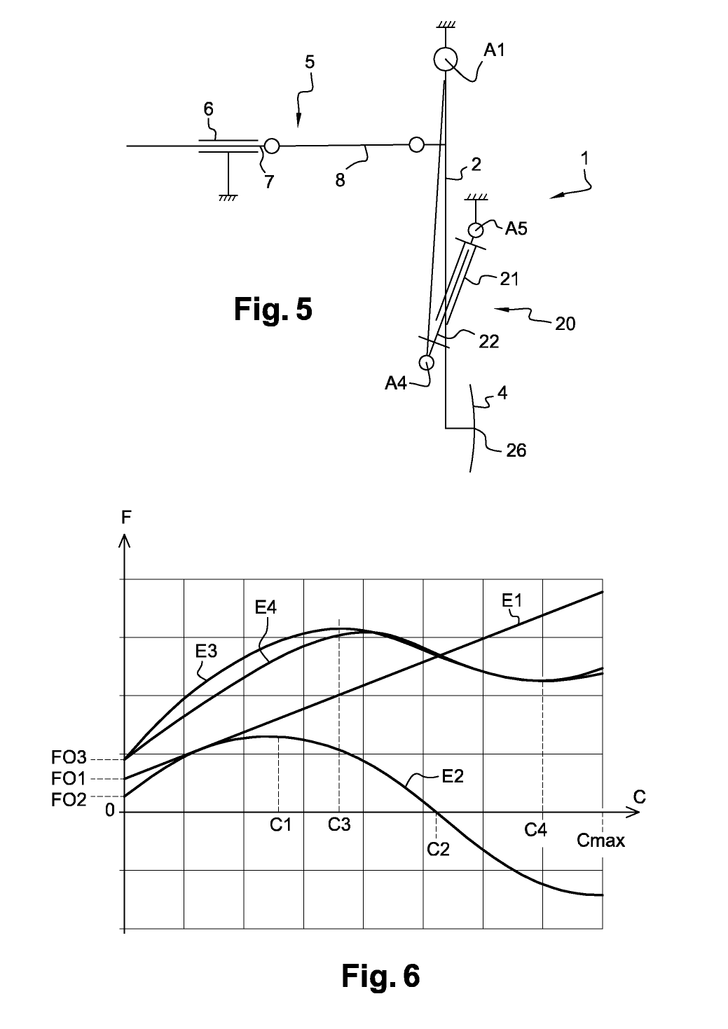

In particular, FIG. 3 shows the device 1 when the clutch pedal 2 is in the idle position or engaged position, FIG. 4 shows the device 1 when the pedal 2 is in an intermediate position, and FIG. 5 shows the device 1 when the pedal 2 is in the disengaged position.

The total travel of the pedal 2 between the engaged and disengaged positions is denoted Cmax. This travel for example corresponds to a pivoting of the pedal 2 around the axis A1 comprised between 20 and 50° C., for example comprised between 30 and 40° C., for example about 34°.

It is possible to define a coordinate system for example having, as origin, the hinge axis A1 of the pedal 2 on the fixed support, and comprising:
a first axis x passing through the hinge axis A1 of the pedal 2 on the fixed support, on the one hand, and through the hinge axis A2 of the connecting rod 8 of the force emulator 5 on the pedal 2, on the other hand,
a second axis y perpendicular to the axis x.

In this coordinate system, in the idle position of the pedal 2, i.e., in the engaged position (FIG. 3), it is possible to define the following coordinates:
the hinge axis A1 of the pedal 2 on the fixed support has coordinates (0; 0),
the hinge axis A2 of the connecting rod 8 of the emulator 5 on the pedal 2 has coordinates (x2; 0),
the hinge axis A3 of the connecting rod 8 of the emulator 5 on the piston 5 has coordinates (x3; y3),
the hinge axis A4 of the rod 22 of the assistance means 20 on the pedal 2 has coordinates (x4; y4),
the hinge axis A5 of the body 21 of the assistance means 20 on the fixed support has coordinates (x5; y5),
the bearing point 26 of the foot on the pedal 2 has coordinates (x6; y6).

In the embodiment shown in FIGS. 1 to 5:
x2 can be comprised between 50 and 70 mm, for example about 60 mm,
x3 can be comprised between 28 and 48 mm, for example about 38 mm,
y3 can be comprised between 88 and 108 mm, for example about 98 mm,
x4 can be comprised between 130 and 160 mm, for example about 145 mm,
y4 can be comprised between −35 and −15 mm, for example about −25 mm,
x5 can be comprised between 80 and 100 mm, for example about 90 mm,
y5 can be comprised between 6 and 26 mm, for example about 16 mm,
x6 can be comprised between 230 and 260 mm, for example about 245 mm,
y6 can be comprised between −90 and −70 mm, for example about −80 mm.

Of course, these values can be modified in whole or in part. In this case, the relative positions of the different hinge axes A1 to A5 are preferably retained, like a change of scale.

FIG. 6 is a diagram showing, on the y-axis, the force seen from the pressing point 26 of the foot, and on the x-axis, the displacement of the travel of the pedal 2. A zero travel corresponds to the idle or engaged position of the pedal 2 (as illustrated in FIG. 3), a travel equal to Cmax corresponding to the disengaged position of the pedal 2 (as illustrated in FIG. 5). The intermediate position shown in FIG. 4 is the position of the device 1 for a travel denoted C2.

This diagram includes several curves, namely:
curve E1, which represents the evolution of the force generated by the emulator 5 on the pedal 2, also called main component, in particular generated by the resilient member 9, seen from the pressing point 26 of the foot on the pedal 2,
curve E2, which represents the evolution of the force generated by the assistance means 20 on the pedal 2, also called auxiliary component, in particular generated by the resilient member 25, seen at the pressing point 26 of the foot on the pedal 2,
curve E3, which represents the evolution of the force generated both by the emulator 5 and by the assistance means 20 on the pedal 2, seen at the pressing point 26 of the foot on the pedal 2,
curve E4, which represents the targeted theoretical curve, namely the characteristic curve of a traditional hydraulic control device of a clutch.

It will be noted that curve E3 is the sum of curves E1 and E2.

It will be noted that curve E1 increases linearly from the origin (zero travel) to the travel Cmax. It will be noted that the force F01 exerted when idle by the emulator 5 is not zero and is positive. F01 is for example comprised between 5 and 30 N.

It will be noted that curve E2 increases from the idle position (zero travel) to a position corresponding to a travel C1. The travel C1 is comprised between 20 and 40%, preferably about 30% of the travel Cmax. Curve E2 next decreases beyond C1, to the value Cmax. As visible in curve E2, the force exerted by the assistance means 20 is positive from the origin to the travel C2, then negative beyond the travel Cmax.

The force is therefore zero for a travel C2, the corresponding position of the device 1 being shown in FIG. 4. It will be noted that, in this position, the axes A1, A4 and A5 are aligned.

It will be noted that the force F02 exerted when idle by the assistance means 20 is not zero and is positive. F02 is for example comprised between 5 and 30 N.

Curve C3 representing the sum of the main component (curve E1) and the auxiliary component (curve E2) thus includes a portion increasing from the origin until reaching the travel C3, and a portion decreasing between the travel C3 and the travel C4, then a new increasing portion, from the travel C4 to the travel Cmax.

The force F03 exerted when idle jointly by the emulator 5 and the assistance means 20 is not zero and is positive. F03 is equal to the sum of F01 and F02.

The total force (curve E3) exerted on the pedal 2 is always positive, such that the latter is always returned toward its engaged position.

It will be noted that curve E3 is very close to the curve C4 to be achieved. The emulator 5 and the assistance means 20 thus make it possible to generate a resistive force at the pressing zone 4 of the pedal 2 that practically perfectly simulates the behavior of the pedal of a traditional hydraulic control device, so as not to bother a user.

In order to further improve user comfort, the device 1 may include friction means at least at one of the hinge axes A1 to A5, so as to generate a hysteresis torque, preferably a variable hysteresis torque as a function of the position of the pedal 2.

According to one embodiment shown in FIGS. 7 to 9, the friction means may include a resilient wavy washer 27 coupled in rotation via coupling tabs 28 to a corresponding hinge element, here to the fixed support 29 at the axis A1, said wavy washer 27 comprising at least one alternation of protruding zones 30 and hollow zones 31. Another element of the hinge, here the pedal 2, comprises one or several protruding studs 32 able to bear on the wavy washer 27. The wavy washer 27 is capable of deforming by compression along the axis A1.

Thus, when the protruding stud(s) 32 compress the wavy washer 27 by bearing on the protruding zones 30, the latter generates substantial friction on the pedal 2, so as to generate a substantial hysteresis torque. Conversely, when the protruding studs 32 are located across from hollow zones 31 of the wavy washer 27, the hysteresis torque is lower, or even zero if the washer 27 is not compressed.

The wavy washer 27 and the protruding studs 32 can be configured such that the hysteresis torque is small or zero when the pedal 2 is in the idle or engaged position and the hysteresis torque is greater over the rest of the travel of the pedal 2. The maximal hysteresis torque is for example comprised between 3 and 12 N·m.

FIGS. 10 to 12 illustrate another embodiment of the invention, which differs from that previously described in that:
x2 can be comprised between 33 and 53 mm, for example about 43 mm,
x3 can be comprised between −4 and 16 mm, for example about 6 mm,
y3 can be comprised between 110 and 140 mm, for example about 125 mm,
x4 can be comprised between −7 and 13 mm, for example about 3 mm,
y4 can be comprised between 30 and 50 mm, for example about 40 mm,
x5 can be comprised between −34 and −14 mm, for example about −24 mm,
y5 can be comprised between 56 and 76 mm, for example about 66 mm,
x6 can be comprised between 230 and 270 mm, for example about 250 mm,
y6 can be comprised between −30 and −10 mm, for example about −20 mm.

Of course, these values can be modified in whole or in part. In this case, the relative positions of the different hinge axes A1 to A5 are preferably retained, like a change of scale.

The operation of the device illustrated in FIGS. 10 to 12 is same as that previously described. It will in particular be noted that, like before, in the intermediate position (FIG. 11—travel C2), the hinge axes A1, A4 and A5 are aligned.

1. A device (1) for electrically controlling a transmission system, comprising:
a clutch pedal (2) able to be actuated by a user between an engaged position and a disengaged position, said pedal (2) being intended to be hinged around a first axis (A1) relative to a fixed support (29), said pedal (2) further including a bearing zone (4) intended to be pressed by the foot of a user,
a force emulator (5) comprising a first part (6) intended to be linked to the fixed support (29) and a second part (7, 8) movable relative to the first part (6), said second part (7, 8) being hinged relative to the clutch pedal (2) around a second axis (A2) offset relative to the first axis (A1), at least one resilient member (9) acting between the clutch pedal (2) and the first part (6) so as to return the clutch pedal (2) toward its engaged position,
assistance means (20) comprising a first part (21) intended to be linked to the fixed support (29), and a second part (22) movable relative to the first part (21), the second part (22) of the assistance means (20) being hinged relative to the clutch pedal (2) around a third axis (A4) offset relative to the first axis (A1) and relative to the second axis (A2), at least one resilient member (25) acting between the first part (21) and the clutch pedal (2).

2. The device (1) according to claim 1, characterized in that the second part (7, 8) of the force emulator (5) comprises a piston (7) mounted translatably in the corresponding first part (6), and a connecting rod (8) hinged around the second axis (A2) relative to the clutch pedal (2), the connecting rod (8) also being hinged (A3) relative to the piston (7).

3. The device (1) according to claim 2, characterized in that the resilient member (9) of the force emulator (5) is mounted between the first corresponding part (6) and the piston (7), or between the first corresponding part (6) and the connecting rod (8), or between the first corresponding part (6) and the pedal (2).

4. The device (1) according to claim 1, characterized in that the resilient member (25) of the assistance means (20) is mounted between the first and second corresponding parts (21, 22).

5. The device (1) according to claim 1, characterized in that the force emulator (5) is configured to generate a resistive force (E1) at the pressing zone (4) of the pedal (2) that increases substantially linearly with the travel of the pedal (2) from its engaged position toward its disengaged position.

6. The device (1) according to claim 1, characterized in that the assistance means (20) are configured to generate a resistive force (E2) at the bearing zone (4) of the pedal (2) that increases, then decreases with the travel of the pedal (2) from its engaged position toward its disengaged position.

7. The device (1) according to claim 6, characterized in that the assistance means (20) are configured to generate a resistive force (E2) at the pressing zone (4) of the pedal (2) that is maximal for a movement of the pedal comprised between 20 and 40%, preferably of about 30%, of the travel of said pedal (2) between its engaged and disengaged positions.

8. The device (1) according to claim 1, characterized in that the assistance means (20) are configured to generate a positive resistive force (E2) at the pressing zone (4) of the pedal (2), over a first part of the travel, then a negative force over a second part of the travel.

9. The device (1) according to claim 8, characterized in that the assistance means (20) are configured to generate a resistive force (E2) at the bearing zone (4) of the pedal (2) that is zero for a displacement of the pedal (2) comprised between 50 and 70%, preferably about 60%, of the travel of said pedal (2) between its engaged and disengaged positions.

10. The device (1) according to claim 1, characterized in that the force emulator (5) and the assistance means (20) are configured to generate a total resistive force (E3) at the pressing zone (4) of the pedal (2) that increases over a first part of the travel, until reaching a displacement (C3) of the pedal (2) comprised between 30 and 60% of the travel of said pedal (2) between its engaged and disengaged positions, then decreases over a second part of the travel, until reaching a displacement (C4) of the pedal (2) comprised between 70 and 100% of the travel of said pedal (2), then increases again over a third part of the travel, until reaching the disengaged position (Cmax) of the pedal (2).

11. The device (1) according to claim 1, characterized in that the force emulator (5) includes at least one sensor (10) able to determine the position of the second part (7) of the emulator (5).

12. The device (1) according to claim 1, characterized in that it comprises friction means (27) at least at one (A1) of the hinge axes, so as to generate a hysteresis torque, preferably a variable hysteresis torque based on the position of the pedal (2).
